(19) United States
(12) Patent Application Publication
(10) Pub. No.: US 2015/0212205 A1
(43) Pub. Date: Jul. 30, 2015

(54) DUAL DIFFERENTIAL DOPPLER MOTION DETECTION

(71) Applicant: NINVE JR. INC., Nassau (BS)

(72) Inventor: Pinhas Shpater, Haifa, IL (US)

(21) Appl. No.: 14/401,720

(22) PCT Filed: Jun. 23, 2014
(86) PCT No.: PCT/CA14/50594

§ 371 Date: Nov. 17, 2014

(30) Foreign Application Priority Data
Jun. 21, 2013 (CA) 2820568

(51) Int. Cl. G01S 13/62; G01S 7/02

(52) U.S. Cl. CPC G01S 13/62; G01S 7/02

(57) ABSTRACT

A motion detector has an RF transceiver configured to transmit a first frequency RF signal and a second frequency RF signal into an area where motion is to be detected. A frequency difference between the first frequency signal and the second frequency signal is small and chosen to cause a calculated range dependent Doppler phase shift between the first frequency and the second frequency. The two resulting Doppler shift signals have a frequency dependent on the movement speed of an object in the area, and a difference in amplitude or signal strength between the Doppler shift signals remains relatively invariant as a function of range for a moving object in the area in comparison with an amplitude or signal strength of the Doppler shift signals. Signal level or signal power of a difference in amplitude between the Doppler shift signals is analyzed for the purpose of movement or range detection.

### TECHNICAL FIELD

This invention relates to the field of motion or range detectors using Doppler motion detection.

### BACKGROUND

Microwave intrusion detectors are well known in the art. The typical application is combined with passive infrared motion detection, they transmit wide beam of microwave (or any other suitable RF wavelength) into an area to be monitored and detect a frequency shift (Doppler shift) in the reflected signal reflected from moving objects within the area. This frequency shift is created by motion and with relation to moving target speed. Microwave intrusion detection is often combined with passive infrared detection to ensure low probability of a false positive detection of intrusion, while enjoying a low probability of false negative detection.

U.S. Pat. No. 8,102,261 describes an improved combined Doppler microwave frequency motion detector and passive infrared (PIR) motion detector in which the Doppler microwave motion detector is able to determine the range of the object in motion. This reference, along with other known techniques for determining the range of objects using multiple microwave frequencies (at least two frequencies) for motion detection, teaches that the phase between at least two reflected Doppler signals determines the distance of the moving object from the detector. Measurement of the range or distance of the moving object is useful for interpreting motion data in the decision process for intrusion detection. These techniques are limited to “open space behavior” and there is no description of problems related to how to measure the range (how to measure a phase shift) when the signal level, therefore signal to noise level, is low or in “closed space” conditions, when the unit is exposed to reflections and multipath signals.

Phase measurement between Doppler signals in indoor conditions, requires sophisticated circuitry and/or processing power and is typically limited to close proximity only. In U.S. Pat. No. 8,102,261, for example, the phase angle is determined using a Fast Fourier Transform, and no further details are provided.

### SUMMARY

Applicant has discovered that the range or distance of a moving object detected using a Doppler microwave frequency motion detector can be determined without needing a direct measurement of the phase delay between two Doppler signals by using measurement of time delay between the two signals, but rather by using a simpler, more effective and accurate method more suitable also to low level and multipath signals obtained typically in dosed environments.

Applicant has discovered that the ratio between the signal level or RMS power level of at least two Doppler shifted signals generated from at least two different transmitted frequencies of a microwave Doppler transceiver can indicate on a linear scale the square of the range or distance of the moving object.

Applicant has discovered that the ratio between the differential signal or RMS power level such a differential signal of at least two Doppler shifted signals generated from at least two different transmitted frequencies of a microwave Doppler transceiver, to the common signal, or RMS level of a common signal, produces a signal proportional to the range, while eliminates the amplitude dependency of the received signal, thus eliminates typical problems related to low SNR signals and to multi-path transmitted-received signals in closed room environments.

Applicant has discovered that the ratio between the differential signal or RMS power level such differential signal of at least two Doppler shifted signals generated from at least two different transmitted frequencies of a microwave Doppler transceiver, to the common signal, or RMS level of a common signal, produces a signal proportional to the range, while eliminating the amplitude dependency of the received signal, thus overcoming the object reflectivity and object size dependency of the detected moving object.

Applicant has discovered that by averaging the ratio between the differential signal or RMS power level such a differential signal of at least two Doppler shifted signals generated from at least two different transmitted frequencies of a microwave Doppler transceiver, to the common signal, or RMS level of a common signal, produces a very accurate signal proportional to the range, where accuracy is controlled by averaging time factor. The higher the averaging time is, the more accurate result can be.

Applicant has discovered that the method discovered here for range or distance of a moving object detected accurately and at extended ranges using a dual Doppler microwave frequency motion detector can be implemented without need for significant additional circuitry or computational resources over a conventional Doppler microwave frequency motion detector.

Applicant has discovered that the accurate range or distance of a moving object, determined using a dual Doppler microwave frequency (or other RF frequency band) motion detector for improving analysis or interpretation of a very low level movement signals obtained from PIR motion sensor to better distinguished very low level movement signals from high level thermal and noise level PIR false movement signals.

Applicant has discovered that the use of range information, and range change, and range change ration, further improves Doppler intrusion detection reliability such that it reaches sufficiently reliable levels for standalone performance without the help of PIR detection.

Applicant has discovered that by measuring the slope of the range value (the range change) a direction of movement (approach/recede) can be determined and can further improve the distinction between true movement detection to false movement detection.

Applicant has discovered that by measuring the slope of the range value (the range change) over time, speed information of the movement is obtained.

Applicant has discovered that by comparing the speed calculated by the “range change” to the speed calculated from Doppler frequency received, a better distinction between false movements and true movements can be obtained when requiring that both calculated speeds matches.

Applicant has discovered that by evaluating the range change obtained by at least two separate movement signals, such as “single step” followed by another “single step” movement, a true movement detection can be determined and distinguished from false movement (such as a swing of a curtain or a tree). The detection system can follow a sequence of increments of movement, and determine from two or more sequential increments whether the sequence represents object movement to be signalled as an intrusion or motion event.

Applicant has discovered that analyzing the differential Doppler signal, rather than one or each Doppler signal separately, greatly improves the immunity to false alarm caused by external electrical noises such as fluorescent lighting, radio frequency interferences, spikes and etc.

Applicant has discovered that by setting the transmitted frequency difference such that at desired maximal detection range, the phase shift between Doppler 1 and Doppler 2 is 180 degrees, and by detecting the differential Doppler signal, or RMS level of the differential Doppler signal, then the signal level and the signal to noise ratio at the maximum range is doubled.

Applicant has discovered that by setting the transmitted frequency difference such that at desired maximal detection range, the phase shift between Doppler 1 and Doppler 2 is 180 degrees, and by detecting the differential Doppler signal, or RMS level of the differential signal, then the signal level difference between the maximal range and close ranges is reduced, thus the dynamic range of the detected signal is increased.

Applicant has discovered that by setting the transmitted frequency difference such that at desired maximal detection range, the phase shift between Doppler 1 and Doppler 2 is 180 degrees, and by detecting the differential Doppler signal or RMS level of the differential signal, then the signal level at close ranges is reduced, therefore, with comparison to a single channel threshold level signal detection, a higher signal is required and the “effective threshold level” for closer objects increases according to closeness to the unit, and thus an improved filtering out of close small object movement (such as close small animal movement) is obtained.

Applicant has discovered that combining the RMS signal level of the differential signal with small proportion of RMS signal of Common signal, (for example: 100% Differential RMS+10% of Common RMS) results in a better overall close range to maximal range “level detection” performance.

Applicant has discovered that the frequencies used can be changed to meet the needs of detection. For example, if two frequencies are used to measure range within a normal 25 m range, and the object is measured to be close to the range limit, the frequencies can be changed to extend the range to 30 m, so as to be able to measure without ambiguity the range, or the frequencies can be changed to set the 180 degree phase difference to 20 m, so that the movement at 25 m is unambiguously measured with a differential signal that drops with movement away from the transceiver. Because the differential signal peaks at 180 degree phase difference, the frequencies can be changed to improve SNR for the range where the object is detected using previous frequencies.

While reference is made herein to using the differential between two frequencies for the purposes of measuring the range, it will be understood that range can be estimated, particularly at close range, using a single frequency Doppler signal strength, or alternatively using phase estimation of two or more Doppler signals, in combination with using the differential signal as described herein.

### BRIEF DESCRIPTION OF THE DRAWINGS

The invention will be better understood by way of the following detailed description of embodiments of the invention with reference to the appended drawings, in which:

FIG. 1 is a schematic block diagram and illustration of a dual microwave frequency Doppler motion and range sensor according one embodiment;

FIG. 2A illustrates the multipath reflections of RF signals in an indoor environment reaching a target:

FIG. 2B illustrates the multipath reflections of RF signals in an indoor environment from a target reaching a transceiver;

FIG. 3A is graph of the two Doppler signals resulted from a movement within an area and generated from two slightly different transmitted frequencies when the moving object is at 2.5 meters, according to one embodiment.

FIG. 3B is graph of the Doppler shift signal detected at two different frequencies when a moving object is at 10 meters, according to one embodiment.

FIG. 3C is graph of the Doppler shift signal detected at two different frequencies when a moving object is at 20 meters, according to one embodiment.

FIG. 4 is a composite graph showing common, differential and the ratio of differential to common signal strength (RMS) for motion toward and away from a microwave transceiver according to one embodiment.

FIG. 5 is a schematic block diagram and illustration of a dual motion detector using the Doppler sensor of FIG. 1 combined with a passive infrared (PIR) motion sensor according to another embodiment, the detector being connected to a security system.

### DETAILED DESCRIPTION

There are some basic possible pieces of information to be gained using dual Doppler detection, namely whether an object is moving in the protected area, the direction of movement, and how far the moving object from the transmitter is. In some applications, detecting motion within the protected area is sufficient. Embodiments of the present invention allow for improved detection of motion without involve range detection. In an advanced mode of detection, the range information is added to motion detection analysis, and thus the distance estimation detection is an added condition to motion detection.

The following description relates to microwave Doppler intrusion detection that detects an intruder moving within an area called the protected premises. Such devices are important to security systems for detecting intrusion or tracking the movement of people or objects. It will be appreciated by those skilled in the art that some embodiments of the present invention can be adapted to detect motion and/or the distance of a moving object within an area for other applications other than security applications, such as but not limited to access control, lighting and home automation, robotics, vehicle pilot systems and aids for the blind, in which movement of objects within an area is detected and/or their distance from the sensor.

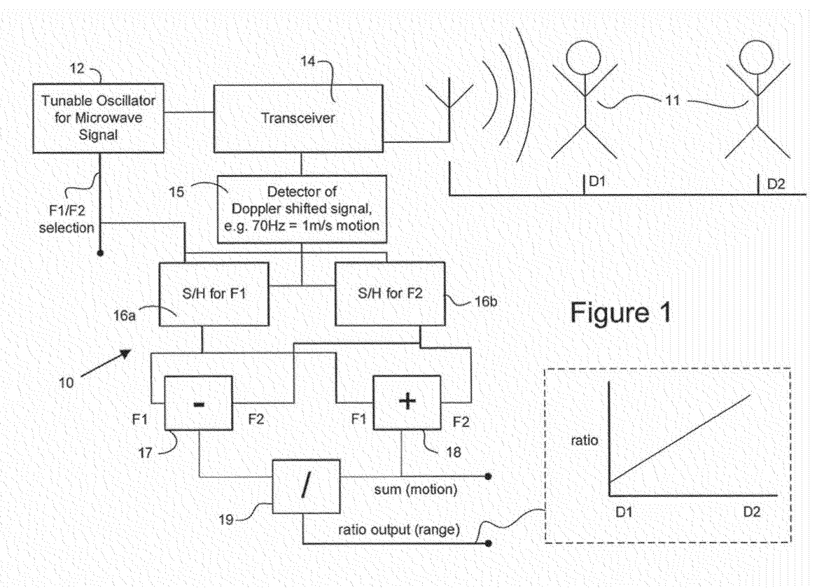

FIG. 1 shows components of one embodiment. A voltage controlled oscillator 12 generates microwave frequency signals at frequencies F1 and F2. The difference between the frequencies is small, for example the difference can be 3 MHz (about 0.01%). For example, F1 can be 10.252 GHz, and F2 can be 10.255 GHz. The setting of frequency differential provides a phase offset between the two Doppler shifted returned signals that will vary from 0 degrees (proximate the transmitting antenna) to close to 180 for the range limit, for example 25m.

While a tunable oscillator is used in this embodiment, it will be appreciated that multiple fixed frequency oscillators can be used in other embodiments.

The phase difference between Doppler signals received by the same antenna at difference frequencies is always zero for zero distance at the antenna itself.

The signals from oscillator 12 are fed to transceiver 14 that transmits the signals via an antenna and receives the signals reflected from various objects within a protected area. Such a transceiver and antenna is well known in the art.

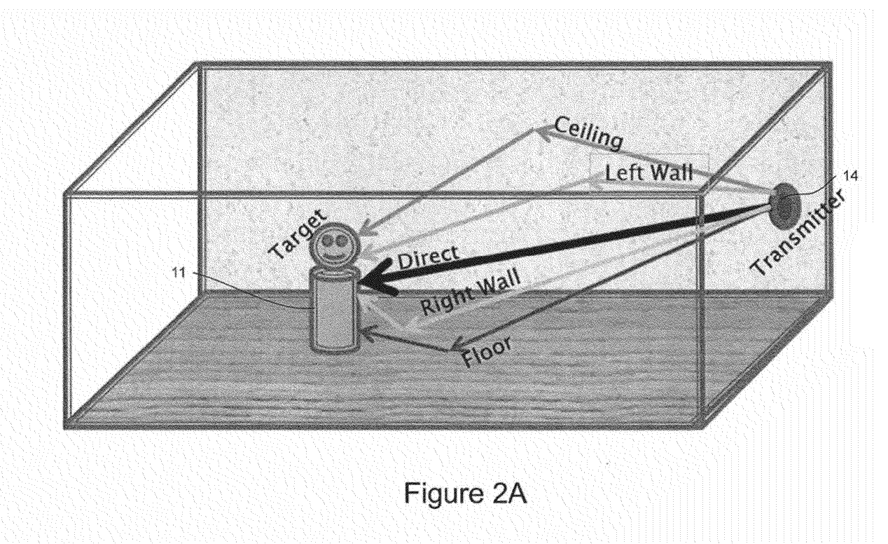

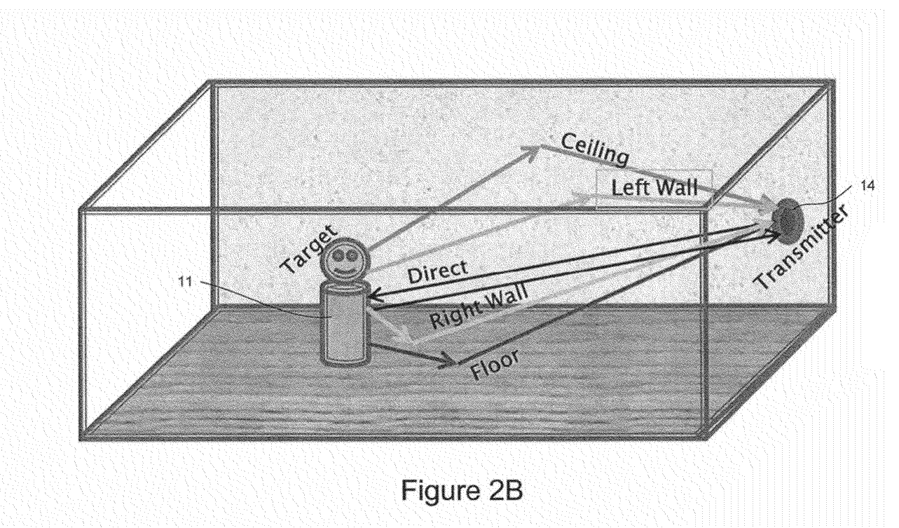

As illustrated in FIG. 2A, the transmitted waves from transceiver 14 also reflected from walls, floor and ceiling and creates additional faded “images” of the transmitter on the target 11. The reflected waves from the protected area similarly have multiple paths from target to receiver that also passes from walls, floor and ceiling and creates additional (faded) images of the target 11, as shown in FIG. 2B. The result for all reflections is that the Doppler signal is not a pure sine wave, but rather it is a complex, amplitude and phase modulated signal, made from the sum of main and reflected sine waves, known in the art as a “multi-path” signal with typical behaviors such as “beat signal” and other problems. Such problems limit the ability to detect the phase shift between two Doppler to only close ranges, where direct path, main transmitted and received signal is much stronger than the sum of non-direct multi-path signals.

The received Doppler signal has a frequency that corresponds with the speed of the moving object, and an amplitude that corresponds with the size and range of the moving object. For the example of 10.525 GHz, an object moving at 1 m/s would create a Doppler signal of about 70 Hz.

Doppler motion detectors are also known in the art. Circuitry measures a shift in frequency in the reflected signal caused by motion of the object from which the signal is being reflected. In the case of intrusion detection, the reflected signal is received from a variety of different objects 11 of different sizes and distances. The received reflection signal is thus a mixture of many reflections and is quite chaotic. However, a moving object 11, either toward or away from the antenna, will provide a shifted frequency.

Thus, the Doppler signal detector circuitry 15 filters out signals reflected at the transmitted frequency and detect signals at shifted frequencies.

The transmitting of two frequencies F1, F2, and receiving 2 Doppler signals, using two sample and hold circuits are well known in the art. For the preferred embodiment described here, a 2 kHz sampling rate for both F1, F2, at 20 μsec transmit period is used. The process continues, taking samples of F1-F2-F1-F2-F1-F2, etc.

The sampling and computation required for producing the difference and sum signals is not negligible. It will be appreciated that full sampling and computation can be done on demand when a lower sampling rate, possibly at a single RF signal being transmitted, indicates object movement. In this way, stand-by power consumption can be reduced.

The Doppler signal processor illustrated in FIG. 1 can be implemented in a microprocessor using suitable software, or it can be implemented in programmable or dedicated hardware/circuitry (analog and/or digital), or a combination thereof, as will be appreciated by those skilled in the art.

Without determining the phase of F1 or F2, the amplitude of F1 and F2 are subtracted in subtracting unit 17 and added in summing unit 18. This is done at a rate of about 2 kHz to have good resolution of the Doppler signal. As described above, the Doppler signal at farther ranges is somewhat chaotic, and determining the phase of signal would be difficult. The units 17 and 18 integrate the differences and sums of the F1 and F2 samples over a suitable period. Integration can take place over fixed time windows, and then start from zero for the next window, or it can involve a moving integration window. Such integration techniques are known in the art.

Divider circuit 19 is configured to take the square root of the ratio of the difference and sum of the F1 and F2 Doppler signals. As described below, the calculated ratio provides a good measure of distance, and the square root of the ratio is a very good linear approximation of distance.

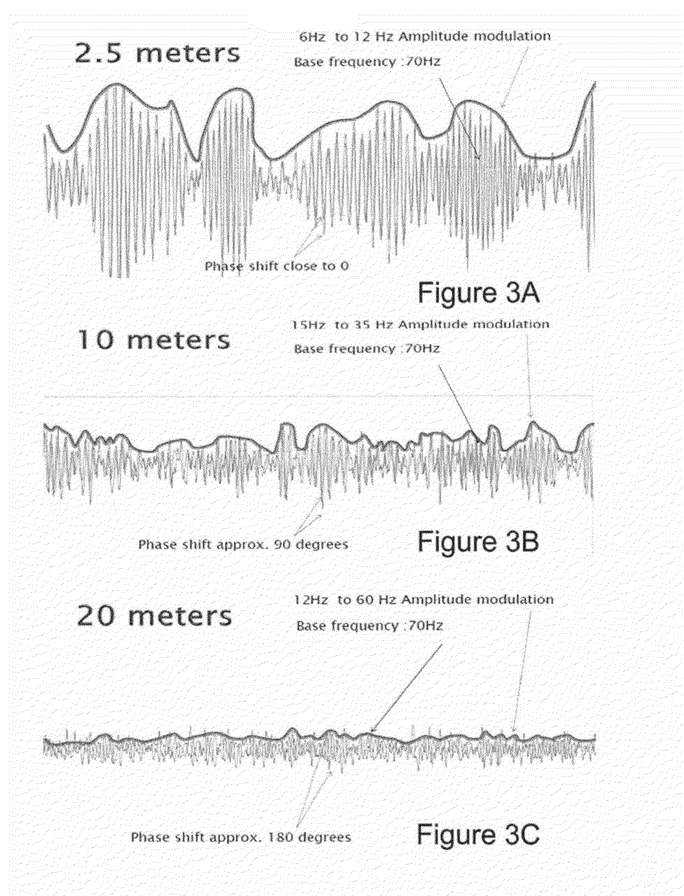

FIGS. 3A, 38 and 3C illustrate a Doppler signal having a base frequency of 70 Hz that corresponds to movement at about 1 m/s for a microwave signal transmitted at about 10.525 GHz. The Doppler signals shown are actual recorded signals. As described above, the multiple reflections give the received signal great variability, and the Doppler signal has an amplitude modulation that varies with a frequency of 6 Hz to 60 Hz, a frequency that varies with range.

FIG. 3A shows the two Doppler signals when the moving object is at 2.5 m from the transmitter. The amplitude of the Doppler signals is therefore strong, and the phase shift between the Doppler signals obtained using F1 and F2 is close to zero. The amplitude modulation at this range at this particular location has a frequency of about 6 to 12 Hz. FIG. 3B shows two Doppler signals when the moving object is at 10 m from the transmitter. The amplitude of the Doppler signals is about a third of the signal shown in FIG. 3A, and the phase shift between the Doppler signals obtained using F1 and F2 is close 90 degrees. The amplitude modulation at this particular location has a frequency of about 15 to 35 Hz.

FIG. 3C shows the two Doppler signals when the moving object is at 20 m from the transmitter. The amplitude of the Doppler signals is about a third of the signal shown in FIG. 3B, and the phase shift between the Doppler signal obtained using F1 and F2 is close to 180 degrees. The amplitude modulation at this particular location has a frequency of about 12 to 60 Hz.

It will be understood that 70 Hz is but one example of a Doppler signal frequency. It represents the Doppler signal frequency for 1 m/s motion directly toward or away from the transceiver for 10.525 GHz microwave transmission. When the motion is of a different radial speed with respect to the transmitter, the frequency of the Doppler signal frequency is reduced, and if movement speed increases, so is the Doppler frequency, and the Doppler detector 15 along with the sampling circuits 16a and 16b can be configured to handle different frequency Doppler signals.

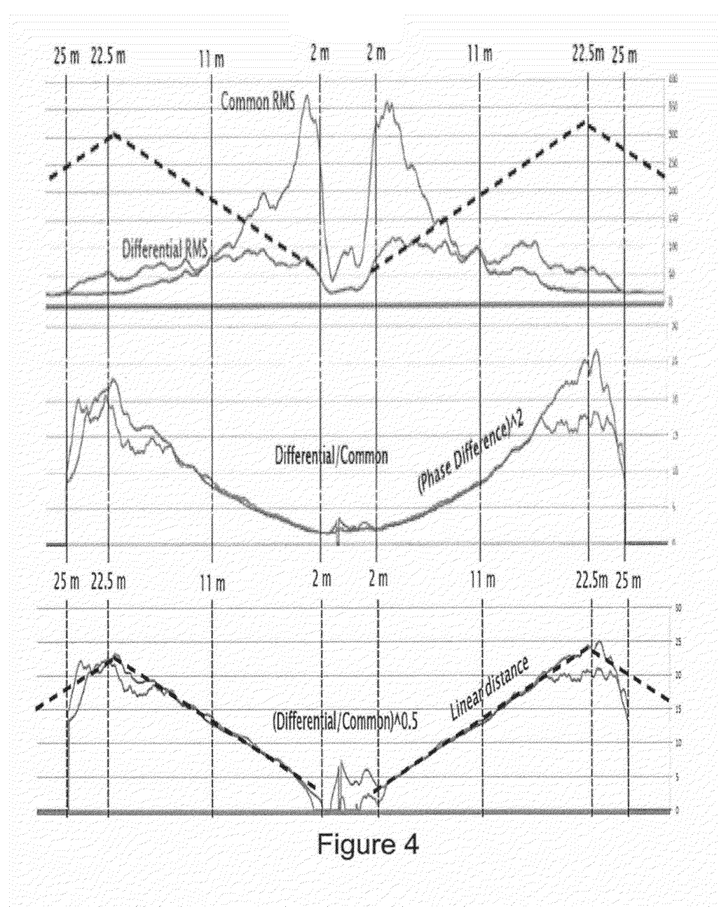

FIG. 4 illustrates the sum or common Doppler signal RMS power of F1 and F2 for motion toward the sensor on the right side and away from the sensor on the left, along with the difference or differential signal power, the middle part of the graph shows the quotient of the differential and the common signal power, and the bottom part of the graph shows the square root of the quotient of the differential and the common signal power. The heavy dashed line shows a good fit for the near linear relation with distance in the bottom graph's square root of the quotient of the differential and the common signal power.

The common or sum power of the Doppler signals, as with any one of the two Doppler signal amplitudes, has a wide dynamic range and decays to very low levels beyond 13 m. It can be appreciated that common signal power level alone might be used to for a threshold level detection for signals from 1 m to 11 m. However, the power of the common signal is not useful for ranges beyond 11 m, and detecting motion using the amplitude beyond 13 m gets more difficult as the threshold of detection decreases and approaches the background noise level.

The sum and difference power level values approach the same value near 1 m in this embodiment, while the differential value does not vary greatly from 2 m to 22.5 m. The difference signal, taken alone without comparison to the common, can be more robust to detect motion within the detection area (e.g. extending out to 22 m) and could use a higher detection threshold that can be used to safely distinguish between motion and background noise over a larger portion of the range. The difference value also changes relatively little as a function of the distance of moving object, whereas the amplitude of the Doppler signal at one or both frequencies depends by the ratio of 1/R². Thus, when using a fixed threshold level for detecting movement, at closer ranges, a higher power level is required from to cross the threshold level, thus objects with lower profile, such as small animals, may not trigger detection. This makes the differential more robust in detecting motion within the protected area.

The accuracy of range detection using embodiments of the present invention can be sufficient to allow for intrusion event detection to be done by considering object displacement within the protected area rather than by detecting motion by Doppler signal amplitude alone.

While in the above embodiment, detection is done using two fixed frequencies, it will be appreciated that detection can be done initially using a first set of frequencies to measure motion detection and/or range, and then the frequencies can be adjusted to improve sensitivity of detection for the range of the object previously detected. After the moving object has left the area covered by the transceiver, the frequencies can be set to the original frequencies that yielded 180 phase difference at the nominal maximum range.

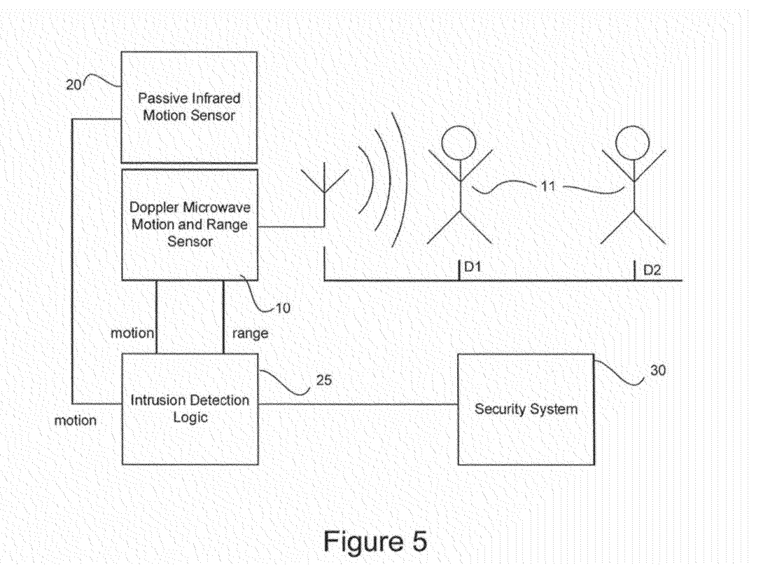

In the embodiment of FIG. 5, the Doppler motion and range sensor 10 is combined with a passive infrared (PIR) sensor 20. The motion detection outputs of the two subunits 10 and 20 are fed to logic 25. The output detection signal from logic 25 is connected over a bus or wirelessly to a security system 30.

Logic 25 can rely on range information to decide on an intrusion event. For example, if a moving object has an oscillatory motion that does not move much radially from the sensor (e.g. curtain swing, or a vibrating object), this can be ignored. Logic 25 can also require that the moving object must move by a predetermined distance before generating an intrusion event, for example movement must be at least 1 m. In other cases where the geometry of an area is known or mapped, motion at certain ranges can be permitted while motion at other ranges can trigger an event.

PIR and Doppler detectors are complementary in that PIR sensors detect motion not only in a radial direction within zones defined by lenslets but also when motion crosses zones defined by lenslets (essentially an angular movement with respect to the sensor), while Doppler detects motion in a toward or away direction with respect to the sensor. While it can be preferred to rely on both PIR and Doppler to detect motion before triggering an event, it can be appreciated that detection of movement in the toward or away direction by over 1.5 m or more, even if no PIR zone boundary is crossed, can be considered to be an unambiguous indication of object movement and thus sufficient to trigger an intrusion event.

Range information can also be useful for interpreting signals from the PIR sensor 20. For example, the range of a moving object can be used to interpret PIR motion signals such that intrusion detection thresholds are higher for objects that the sensor 10 determines to be at a close range, and similarly such that intrusion detection thresholds are lower for objects that the sensor 10 determines to be at a far range. Range information can also be used to program an intrusion detector to ignore motion within certain ranges, as the installer or user may determine to be most suitable for the protected premises.

1. A motion detector comprising:
a Doppler RF transceiver configured to transmit a first frequency RF signal and a second frequency RF signal into an area where motion is to be detected,
a frequency difference between the first frequency signal and the second frequency signal being small and chosen to cause a calculated range dependent Doppler phase shift between the first frequency and the second frequency; and
said RF transceiver configured to detect the first frequency RF signal and the second frequency RF signal reflected from the area and to produce at least two Doppler shift signals having a frequency dependent on the movement speed of an object in said area contributing to the first frequency RF signal and the second frequency RF signal reflected from said area;
wherein signal level or signal power of a difference in amplitude between the Doppler shift signals is analyzed for the purpose of movement or range detection.

2. The detector as claimed in claim 1, comprising:
a processor configured to subtract the Doppler shift signals and integrate their difference.

3. The detector as claimed in claim 1, comprising:
a processor configured to calculate a ratio of a difference in amplitude or signal power between the Doppler shift signals and an amplitude or signal power of at least one of the Doppler shift signals.

4. The detector as claimed in claim 3, wherein the amplitude or signal power of at least one of the Doppler shift signals is determined from a sum of an amplitude or signal power of both of the Doppler shift signals.

5. The detector as claimed in claim 3, wherein the processor configured to calculate the ratio of the difference is configured to calculate a square root of the difference in amplitude between the Doppler shift signals and an amplitude of at least one of the Doppler shift signals.

6. The detector as claimed in claim 1,
comprising intrusion logic configured to process a difference between the Doppler shift signals to generate an intrusion signal.

7. The detector as claimed in claim 3,
comprising intrusion logic configured to process said ratio to generate an intrusion signal as a function of a change in measured range of said object in said area.

8. The detector as claimed in claim 7, wherein said intrusion logic analyzes a sequence of measured range changes to generate the intrusion signal.

9. The detector as claimed in claim 6, wherein said intrusion logic generates the intrusion signal on the basic of motion determined using said difference without determining range from said difference.

10. The detector as claimed in claim 1, wherein the RF transceiver comprises a tunable oscillator.

11. The detector as claimed in claim 10, wherein the RF transceiver comprises a voltage controlled oscillator and is configured to change a voltage control to transmit the first frequency RF signal and the second frequency RF signal alternatingly.

12. The detector as claimed in claim 1, wherein said frequency difference is selected to provide a 180 degree phase shift between reflected signal of the first frequency signal and the second frequency signal near a maximum range.

13. The detector as claimed in claim 1, wherein the first frequency signal and the second frequency signal are transmitted alternatingly and said at least two Doppler shift signals are sampled alternatingly, preferably at a sampling rate above 1 kHz per signal, and more preferably at a sampling rate above 2 kHz per signal.

14. The detector as claimed in claim 1, wherein said RF transceiver is configured to send microwave signals, preferably X band or K band microwave signals.

15. The detector as claimed in claim 1,
comprising circuitry configured to generate a range estimation signal using said difference in amplitude or signal strength between the Doppler shift signals.

16. The detector as claimed in claim 1, comprising circuitry configured to generate a motion signal using said difference in amplitude or signal strength between the Doppler shift signals.

17. The detector as claimed in claim 16, wherein said motion signal is determined by comparing said difference to a threshold.

18. The detector as claimed in claim 17, wherein said threshold is a combination of said difference and an amplitude or power of at least one of said two Doppler shift signals, preferably 100% RMS of said difference+10% of RMS of a common of said two Doppler shift signals.

19. The detector as claimed in claim 16, wherein said motion signal is determined from a change in range detected using said difference.

20. The detector as claimed in claim 1, further comprising a passive infrared motion sensor.

21. The detector as claimed in claim 1, wherein said detector is a security system motion detector.
